(19) United States
(12) Patent Application Publication
(10) Pub. No.: US 2026/0140326 A1
(43) Pub. Date: May 21, 2026

(54) FIBER OPTIC FERRULE ASSEMBLY ADAPTER

(71) Applicant: Domaille Engineering, LLC, Rochester, MN (US)

(72) Inventors: Gregory A. Schumacher, Plainview, MN (US); Justin R. Eide, Rochester, MN (US); Paul S. Fishbaugher, Rochester, MN (US); Jill B. Christie, St. Charles, MN (US)

(73) Assignee: Domaille Engineering, LLC, Rochester, MN (US)

(21) Appl. No.: 18/952,265

(22) Filed: Nov. 19, 2024

(51) Int. Cl. G02B 6/38

(52) U.S. Cl. CPC G02B 6/3825; G02B 6/3821; G02B 6/3841; G02B 6/3897

(57) ABSTRACT

A fiber optic ferrule assembly adapter for use with a fiber optic ferrule assembly, which includes at least one optical fiber routed through a connector portion, comprises a frame portion and an engaging member. The frame portion includes an aperture configured and arranged to receive the connector portion of the fiber optic ferrule assembly. The engaging member is operatively connected to the frame portion and is positioned proximate a first side of the aperture. When the fiber optic ferrule assembly is positioned within the aperture, the engaging member is configured and arranged to bias the connector portion toward an opposing second side of the aperture and selectively retain the connector portion within the aperture.

### BACKGROUND

A fiber optic cable or ribbon generally includes a protective or supporting material through which optical fibers extend. The cable or ribbon typically has a connector, including a ferrule, operatively connected to each end to connect them to other fiber optic cables or ribbons or to peripheral devices, and the connectors are high precision devices that position the optical fibers for optimal connection.

In order to pass light signals through optical fibers, the end face of the connector (from which a ferrule and optical fibers extend) must abut an adjacent connector in a specific manner. The high tolerances required of the parts to make these connections lead to precise shaping of the ends of the optical fibers via cleaving, cutting, and/or polishing. Apex offset, radius of curvature, fiber protrusion/recession, and angularity are all geometric parameters of the optical fiber end face that play into the quality of the signal passing through it. Final test measurements for back reflection and insertion loss are typically used as the final checks to determine the quality of the geometry (as well as the alignment, cleanliness, and surface finish of the finished cable). As such, the end face is usually cleaved, cut and/or polished to exacting standards so as to produce a finished product with minimal back reflection and loss. For example, it is often necessary to cleave, cut, and/or polish the end face of the connector to a precise length, i.e., so the end face projects a predetermined amount from a reference point such as a shoulder on the fiber optic connector within a predetermined tolerance. Fiber optic cables having multiple optical fibers can also be cleaved, cut, and/or polished to produce a particular performance specification.

Cleaving can be accomplished via a mechanical or laser cleaving process. In some examples, especially with mechanical cleaving, the cleaving process is an initial process and then the ends of the fibers are polished. In some examples, especially with laser cleaving, the cleaving process produces a desired finish without polishing although polishing may still be conducted.

Laser cleaving devices typically require a user to change the fixture or the adapter when running a different type of product to accommodate different types of connectors as well as different end face angles for connectors. Ease of use and secure connection of the adapters are important for efficiency and accuracy.

Microscopes can be used to inspect ends of the optical fibers, and adapters can be used to hold the fiber optic ferrule assemblies steady during inspection. Again, ease of use and secure connection are important.

For the reasons stated above and for other reasons stated below, which will become apparent to those skilled in the art upon reading and understanding the present specification, there is a need in the art for a fiber optic ferrule assembly adapter.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a fiber optic ferrule assembly adapter for use with a fiber optic ferrule assembly, which includes at least one optical fiber routed through a connector portion, comprises a frame portion and an engaging member. The frame portion includes an aperture configured and arranged to receive the connector portion of the fiber optic ferrule assembly. The engaging member is operatively connected to the frame portion and is positioned proximate a first side of the aperture. When the fiber optic ferrule assembly is positioned within the aperture, the engaging member is configured and arranged to bias the connector portion toward an opposing second side of the aperture and selectively retain the connector portion within the aperture.

In one embodiment, a fiber optic ferrule assembly adapter for use with a fiber optic ferrule assembly, which includes at least one optical fiber routed through a connector portion, comprises a frame portion, a biasing member, and an engaging member. The frame portion includes an aperture configured and arranged to receive the connector portion of the fiber optic ferrule assembly. The biasing member is operatively connected to the frame portion. The engaging member is positioned proximate a first side of the aperture and the biasing member is positioned between the frame portion and the engaging member to place a biasing force on the engaging member away from the frame portion toward an opposing second side of the aperture. When the fiber optic ferrule assembly is positioned within the aperture, the biasing member biases the connector portion toward the opposing second side of the aperture and selectively retains the connector portion within the aperture.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a perspective view of an optical fiber laser cleaving device including an embodiment a fiber optic ferrule assembly adapter constructed in accordance with the principles of the present invention;

FIG. 2 is a perspective view of a fiber optic ferrule assembly for use with the fiber optic ferrule assembly adapter shown in FIG. 1;

FIG. 3 is a side view of the fiber optic ferrule assembly shown in FIG. 2;

FIG. 4 is a bottom view of the fiber optic ferrule assembly shown in FIG. 2;

FIG. 5 is a perspective view of the fiber optic ferrule assembly adapter shown in FIG. 1;

FIG. 6 is a top view of the fiber optic ferrule assembly adapter shown in FIG. 5;

FIG. 7 is a bottom view of the fiber optic ferrule assembly adapter shown in FIG. 6;

FIG. 8 is a side view of the fiber optic ferrule assembly adapter shown in FIG. 6;

FIG. 9 is a partially exploded perspective view of the fiber optic ferrule assembly adapter shown in FIG. 5;

FIG. 10 is a perspective view of a spring plunger assembly of the fiber optic ferrule assembly adapter shown in FIG. 5;

FIG. 11 is an exploded perspective view of the spring plunger assembly shown in FIG. 10;

FIG. 12 is a top view of the fiber optic ferrule assembly adapter shown in FIG. 5;

FIG. 13 is a cross-section view of the fiber optic ferrule assembly adapter shown in FIG. 12 taken along the lines 13-13 in FIG. 12;

FIG. 14 is a top view of the fiber optic ferrule assembly adapter shown in FIG. 5 with the fiber optic ferrule assembly shown in FIG. 2 connected thereto;

FIG. 15 is a cross-section view of the fiber optic ferrule assembly adapter and the fiber optic ferrule assembly shown in FIG. 14, in a partially inserted position, taken along the lines 15-15 in FIG. 14;

FIG. 16 is a cross-section view of the fiber optic ferrule assembly adapter and the fiber optic ferrule assembly shown in FIG. 14, in a fully inserted position, taken along the lines 16-16 in FIG. 14;

FIG. 17 is a perspective view of an optical fiber laser cleaving device including another embodiment a fiber optic ferrule assembly adapter constructed in accordance with the principles of the present invention;

FIG. 18 is a perspective view of a fiber optic ferrule assembly for use with the fiber optic ferrule assembly adapter shown in FIG. 17;

FIG. 19 is a side view of the fiber optic ferrule assembly shown in FIG. 18;

FIG. 20 is a bottom view of the fiber optic ferrule assembly shown in FIG. 18;

FIG. 21 is a perspective view of the fiber optic ferrule assembly adapter shown in FIG. 17;

FIG. 22 is a top view of the fiber optic ferrule assembly adapter shown in FIG. 21;

FIG. 23 is a bottom view of the fiber optic ferrule assembly adapter shown in FIG. 22;

FIG. 24 is a side view of the fiber optic ferrule assembly adapter shown in FIG. 22;

FIG. 25 is a partially exploded perspective view of the fiber optic ferrule assembly adapter shown in FIG. 21;

FIG. 26 is an exploded perspective view of a spring plunger assembly of the fiber optic ferrule assembly adapter shown in FIG. 21;

FIG. 27 is a top view of the fiber optic ferrule assembly adapter shown in FIG. 21;

FIG. 28 is a cross-section view of the fiber optic ferrule assembly adapter shown in FIG. 27 taken along the lines 28-28 in FIG. 27;

FIG. 29 is a top view of the fiber optic ferrule assembly adapter shown in FIG. 21 with the fiber optic ferrule assembly shown in FIG. 18 connected thereto;

FIG. 30 is a cross-section view of the fiber optic ferrule assembly adapter and the fiber optic ferrule assembly shown in FIG. 29, in a partially inserted position, taken along the lines 30-30 in FIG. 29;

FIG. 31 is a cross-section view of the fiber optic ferrule assembly adapter and the fiber optic ferrule assembly shown in FIG. 29, in a fully inserted position, taken along the lines 31-31 in FIG. 29;

FIG. 32 is a perspective view of a microscope including another embodiment a fiber optic ferrule assembly adapter constructed in accordance with the principles of the present invention;

FIG. 33 is a perspective view of the fiber optic ferrule assembly adapter shown in FIG. 32;

FIG. 34 is a top view of the fiber optic ferrule assembly adapter shown in FIG. 33;

FIG. 35 is a bottom view of the fiber optic ferrule assembly adapter shown in FIG. 33;

FIG. 36 is a perspective view of the fiber optic ferrule assembly adapter shown in FIG. 33;

FIG. 37 is an exploded perspective view of the fiber optic ferrule assembly adapter shown in FIG. 33;

FIG. 38 is a top view of the fiber optic ferrule assembly adapter shown in FIG. 33;

FIG. 39 is a cross-section view of the fiber optic ferrule assembly adapter shown in FIG. 38 taken along the lines 39-39 in FIG. 38;

FIG. 40 is a top view of the fiber optic ferrule assembly adapter shown in FIG. 33 with the fiber optic ferrule assembly shown in FIG. 2 connected thereto;

FIG. 41 is a cross-section view of the fiber optic ferrule assembly adapter and the fiber optic ferrule assembly shown in FIG. 40, in a partially inserted position, taken along the lines 41-41 in FIG. 40;

FIG. 42 is a cross-section view of the fiber optic ferrule assembly adapter and the fiber optic ferrule assembly shown in FIG. 40, in a fully inserted position, taken along the lines 42-42 in FIG. 40.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a fiber optic ferrule assembly adapter configured and arranged to receive a connector portion of a fiber optic ferrule assembly within an aperture. A biased engaging member positioned proximate one side of the aperture is configured and arranged to bias the connector portion toward an opposing side of the aperture and retain the connector portion within the aperture. In an example, the engaging member is biased with a biasing member. In an example, the engaging member is a cylindrical rod and the biasing member is a spring plunger.

In some embodiments, an optical fiber laser cleaving device is configured and arranged to receive an adapter for one or more different types of fiber optic ferrule assemblies. In some embodiments, the adapter is interchangeable with one or more different adapter(s). The laser cleaving device includes a housing that contains a laser cutting system for cleaving end(s) of one or more optical fibers. The selected adapter is configured and arranged to hold and position the optical fiber(s) with respect to the laser cutting system to facilitate desired cleaving. An example of a laser cleaver that could be used is the OptiSaber™ OS7000M by Domaille Engineering, LLC located in Rochester, MN. Another example is the laser cleaving device disclosed in U.S. Pat. No. 9,690,048 B2, which is incorporated herein by reference.

In some embodiments, an adapter or adapters for one or more different types of fiber optic ferrule assemblies is/are configured and arranged to operatively connect to a microscope. In some embodiments, the adapter receives an insert that is interchangeable with one or more different adapter insert(s). In some embodiments, the microscope can be used with more than one adapter, which could include insert(s) for the same or different types of fiber optic ferrule assemblies. An example of a microscope that could be used is one from the OptiSpec™ line of microscopes by Domaille Engineering, LLC located in Rochester, MN.

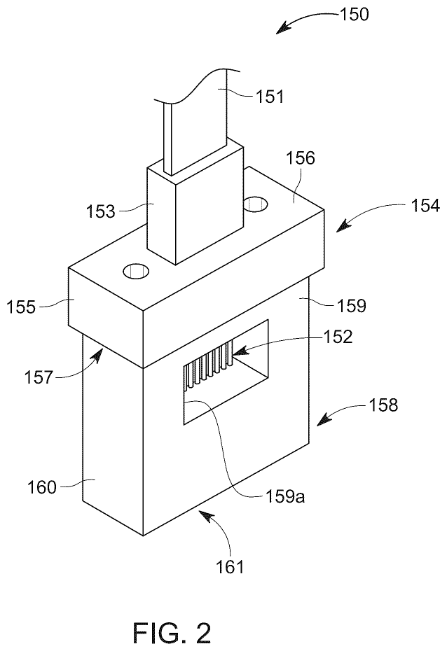

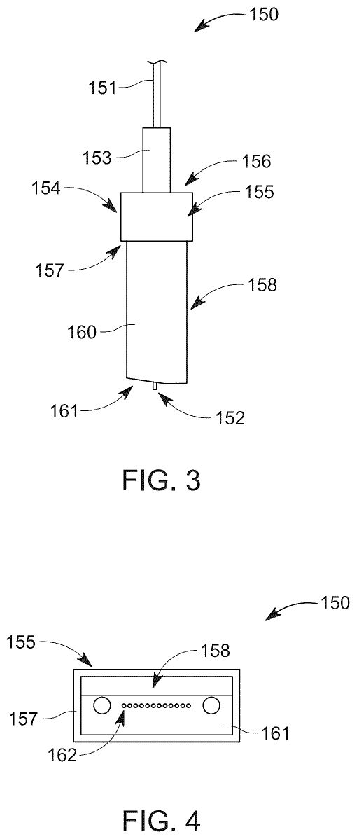

FIGS. 2-4 illustrate an example fiber optic MT ferrule assembly 150 that can be used with an optical fiber laser cleaving device 100, a microscope 300, or other device. The fiber optic MT ferrule assembly 150 includes a connector portion 154 operatively connected to an end portion of a fiber cable or ribbon 151 through which fibers 152 extend. The connector portion 154 includes a ferrule 158 with a strain relief 153 to support the fiber cable or ribbon 151. The ferrule 158 has a shoulder 155 and fiber bores 162, which extend through the ferrule 158 to allow the fibers 152 to extend through the ferrule 158 and be cleaved preferably coplanar to the ferrule end face 161. The shoulder 155 includes a top face 156, to which the strain relief 153 is attached, and a bottom face 157. In some embodiments, at least one side face of a set of opposing side faces 159 and 160 includes a window 159a. The ferrule 158 generally includes an end face 161 from which the fibers 152 extend out of the fiber bores 162. The shoulder's bottom face 157 is preferably manufactured substantially parallel with the ferrule end face 161. Thus, according to some embodiments, the ferrule end face 161 may be squared within a fixture with reference to the shoulder bottom face 157.

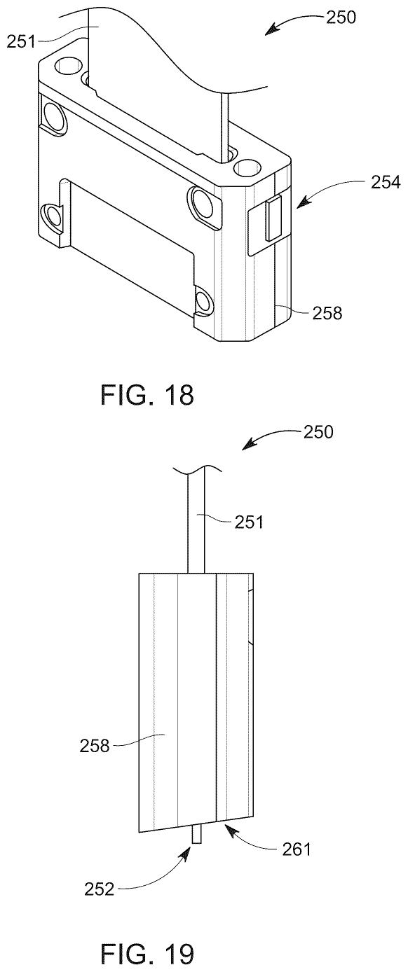

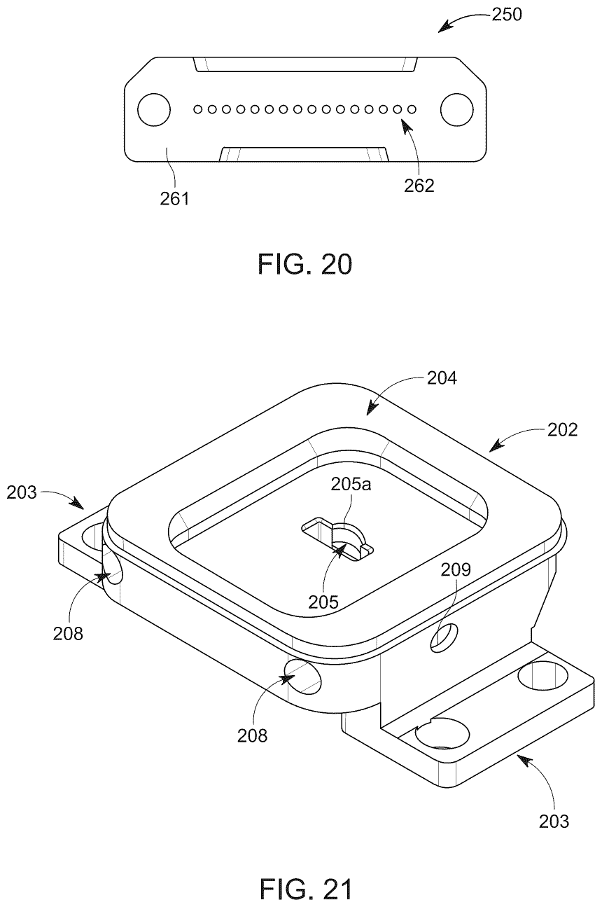

FIGS. 18-20 illustrate an example fiber optic TMT ferrule assembly 250 that can be used with an optical fiber laser cleaving device 200, a microscope, or other device. The fiber optic TMT ferrule assembly 250 includes a connector portion 254 operatively connected to an end portion of a fiber cable or ribbon 251 through which fibers 252 extend. The connector portion 254 includes a ferrule 258 through which the fibers 252 also extend, and the ferrule 258 includes an end face 261 from which the fibers 252 extend out of the fiber bores 262.

Although example MT and TMT ferrule assemblies are shown and described, it is recognized that other suitable types of assemblies for use with any suitable non-round ferrules (such as but not limited to MT ferrules, TMT ferrules, MTRJ ferrules, and fiber arrays) could be used.

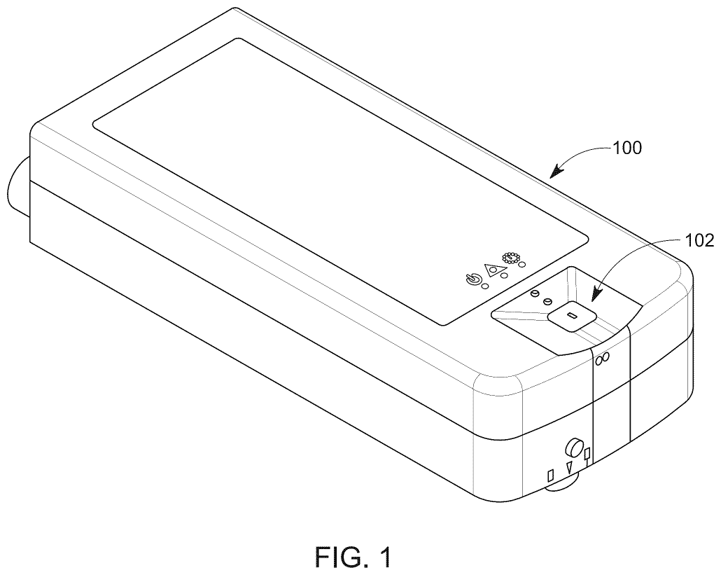

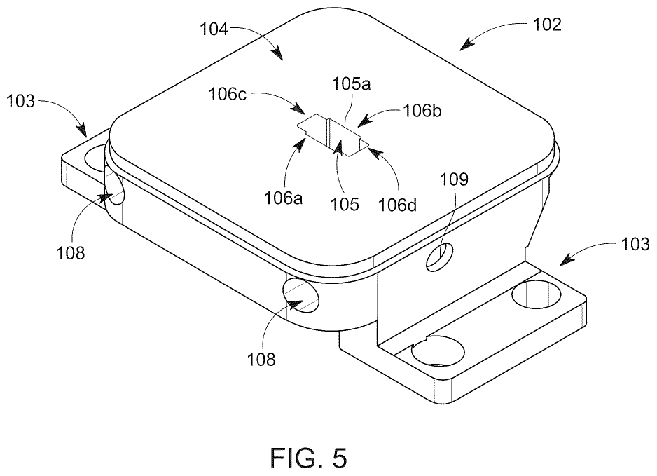

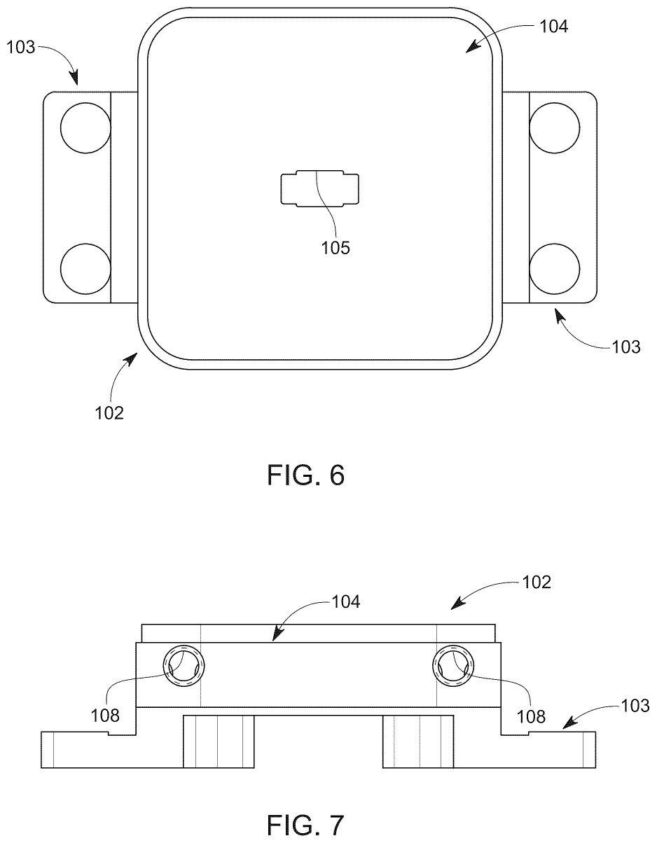

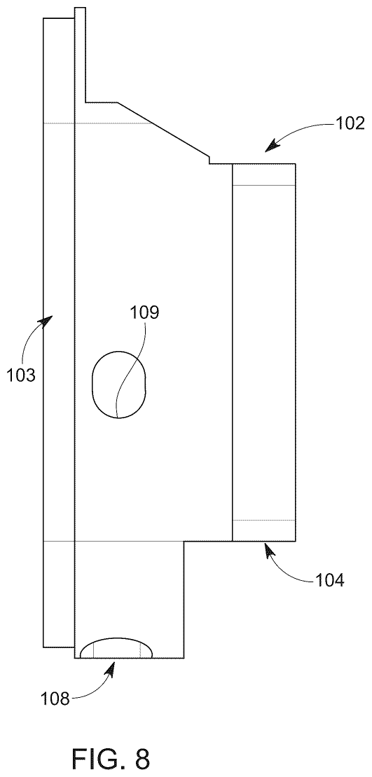

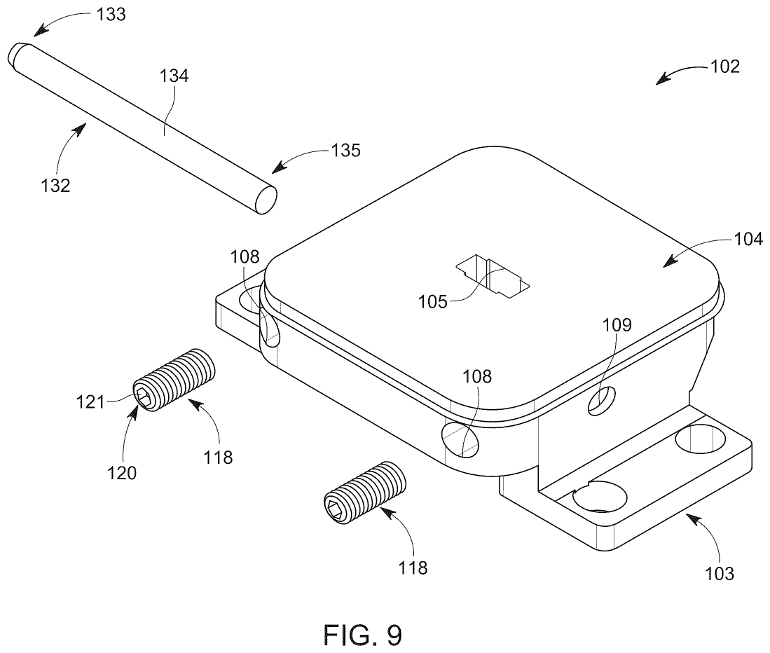

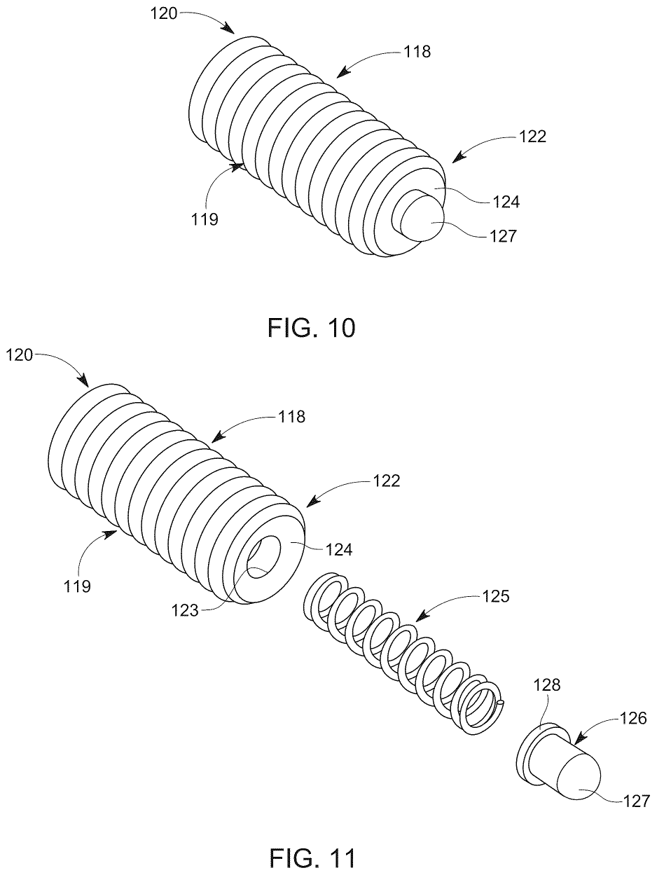

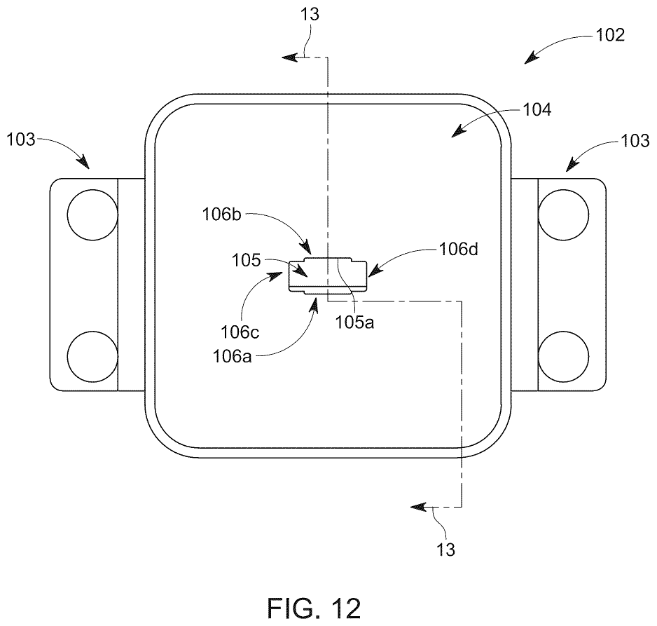

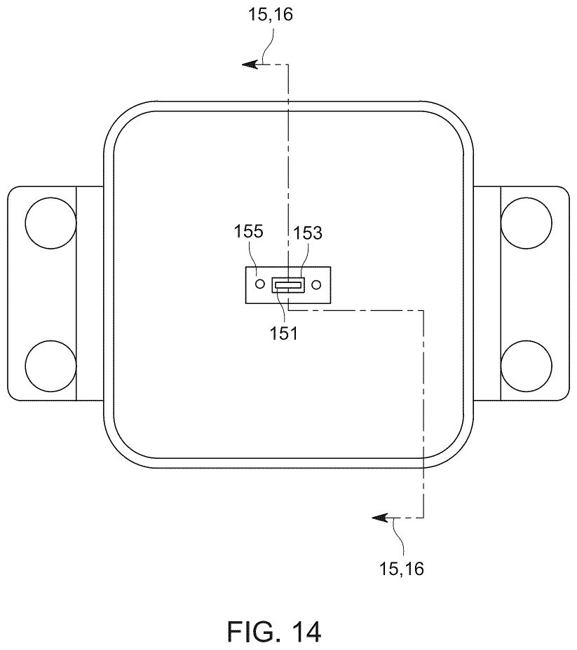

In one embodiment, illustrated in FIGS. 5-9 and 12-16, a fiber optic ferrule assembly adapter 102 can be used with a suitable optical fiber laser cleaving device, such as device 100 illustrated in FIG. 1, for connecting the fiber optic MT ferrule assembly 150 thereto. In this example, the adapter 102 includes a mounting portion 103, configured and arranged to mount onto the device 100, and a frame portion 104, configured and arranged to receive the ferrule assembly 150. The frame portion 104 includes an aperture 105 with an opening 105a formed by opposing first and second sides 106a and 106b and opposing third and fourth sides 106c and 106d configured and arranged to receive the connector portion 154 of the ferrule assembly. The frame portion 104 also includes lateral bores 108 that intersect with and are in communication with a longitudinal bore 109. The lateral bores 108 are preferably positioned on opposing sides of the aperture 105, parallel to the third and fourth sides 106c and 106d, and a portion of the longitudinal bore 109 intersects the first side 106a, parallel to the first side 106a.

The lateral bores 108 are configured and arranged to receive biasing members 118, which in this example are spring plungers. It is recognized that a ball plunger or other suitable biasing member could also be used. Preferably, the lateral bores are formed by at least partially threaded walls 116 that are configured and arranged to mate with threaded exteriors 119 of the biasing members 118. This assists in keeping the biasing members 118 in desired positions relative to the frame portion 104. The biasing members 118 include generally cylindrical housings each having a first end 120, which forms a hex nut 121, and a second end 122 which forms a stop 124 narrowing an opening into a bore 123. A spring 125 is positioned in the bore 123 proximate the first end 120 with a ball portion 126 proximate the second end 122 so that the spring 125 biases the ball portion 126 to partially extend through the opening into the bore 123 formed by the stop 124. The ball portion 126 includes a flange 128 and a ball end 127. The spring 125 exerts force on the flange 128, and the flange 128 selectively contacts the stop 124 to prevent the ball portion 126 from coming out of the bore 123. The ball end 127 protrudes from the opening formed by the stop 124.

An engaging member 132, which is preferably a rod, extends through the longitudinal bore 109, which is preferably an oval shaped bore to allow the engaging member 132 to slide or translate between receiving/releasing and retaining positions relative to the aperture 105. The engaging member 132 is biased by the biasing members 118 into the retaining position, but as the connector portion 154 is inserted into and removed from the aperture 105, the engaging member 132 presses against the ball portions 126, thereby moving the ball portions 126 inward and compressing the springs 125, toward the receiving/releasing position. In this example, the engaging member 132 is a cylindrical rod having a first end 133, an intermediate portion 134, and a second end 135. A portion of the intermediate portion 134 is configured and arranged to contact the connector portion 154 within the aperture 105 and bias the connector portion 154 toward the opposing side, the second side 106b. The engaging member 132 contacts the connector portion 154 to more securely retain the connector portion within the aperture 105.

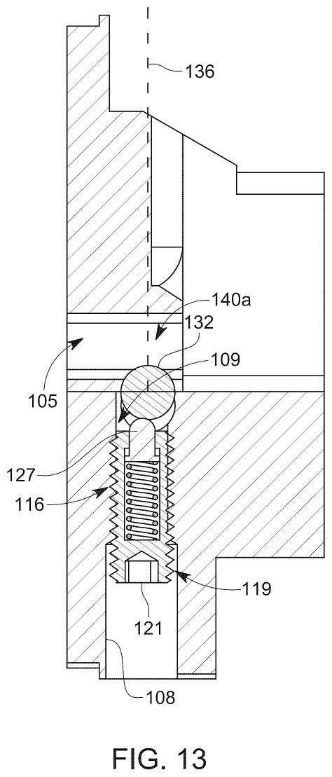

Preferably, to also more securely retain the connector portion 154 within the aperture 105, the diameter of the cylindrical rod is a center line 136, illustrated in FIGS. 13, 15, and 16, and the ball portion 126 engages the engaging member 132 off center relative to the center line 136, preferably off center proximate the opening 105a to the aperture 105.

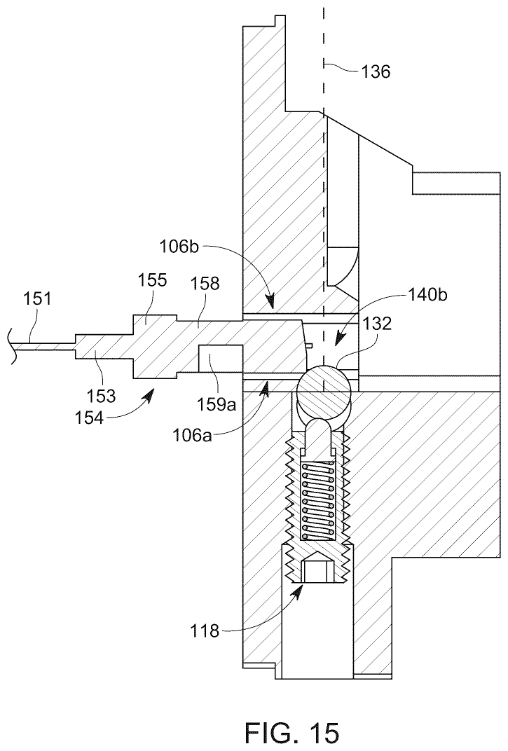

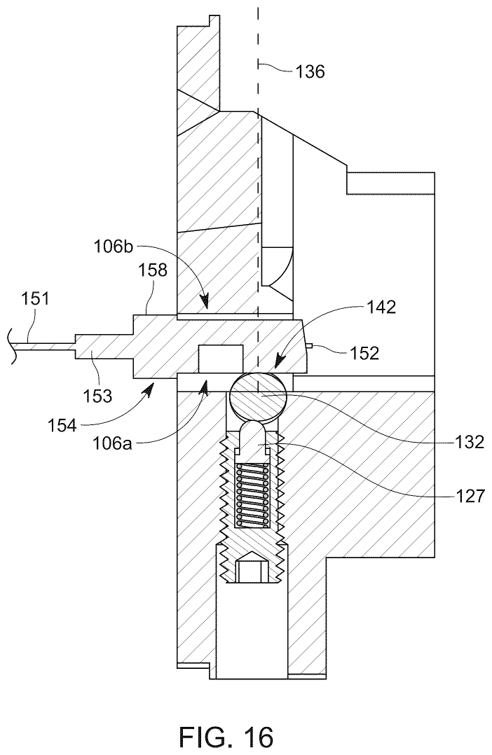

In operation, as illustrated in FIGS. 13, 15, and 16, as the connector portion 154 is inserted into the aperture 105, it contacts the engaging member 132, which rotates and slides or translates inward toward the biasing members 118, moving the ball portions 126 and compressing the springs 125. The receiving/releasing position includes a variety of positions from when the engaging member 132 is not contacted by the connector portion 154 to when it is partially contacted or engaged by the connector portion 154, for example the receiving/releasing positions 140a and 140b illustrated in FIGS. 13 and 15. When the connector portion 154 is positioned within the aperture 105, the engaging member 132 is biased by the biasing members 118 thereby biasing the connector portion 154 toward the second side 106b. The retaining position 142 is illustrated in FIG. 16. As the connector portion 154 is removed from the aperture 105, the engaging member 132 rotates and slides or translates inward toward the biasing members 118, moving the ball portions 126 and compressing the springs 125. In addition, preferably the engaging member 132 is configured and arranged to rotate as the connector portion 154 is inserted into and removed from the aperture 105 to assist in reducing wear on the engaging member 132 and preventing marring or drag marks on the connector portion 154.

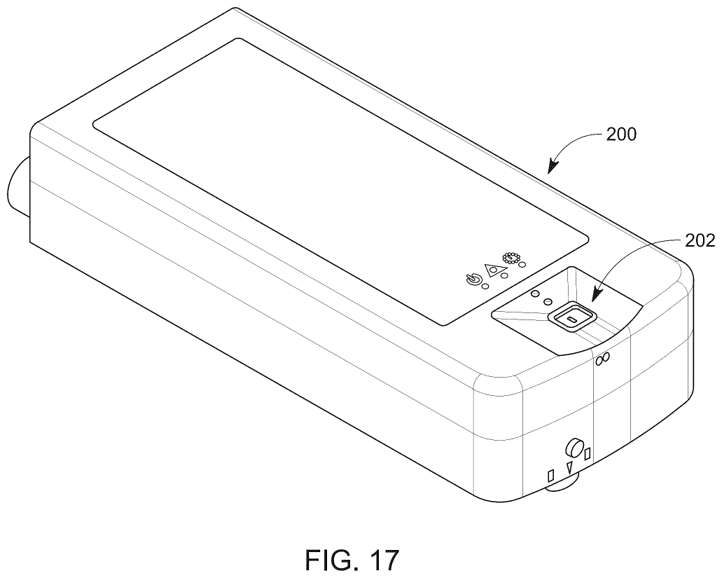

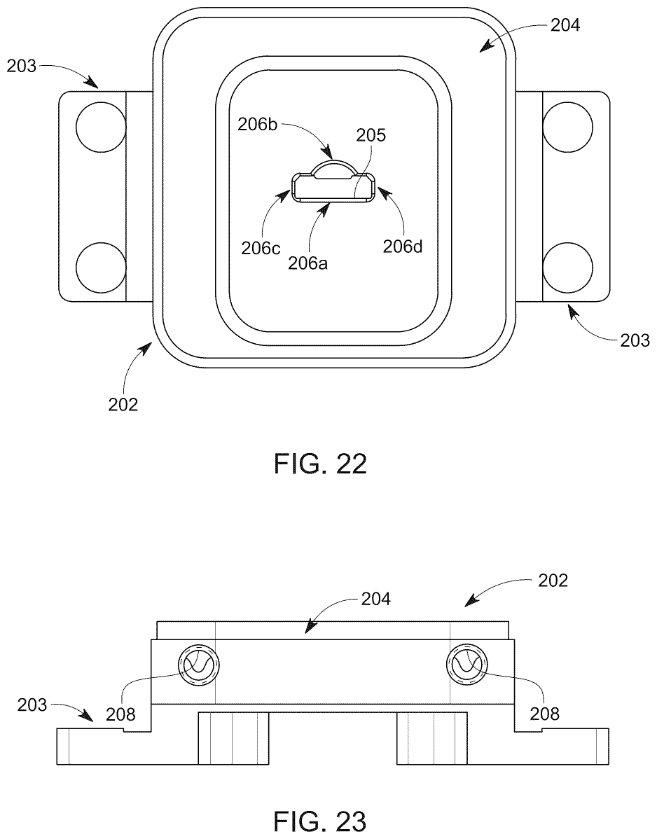

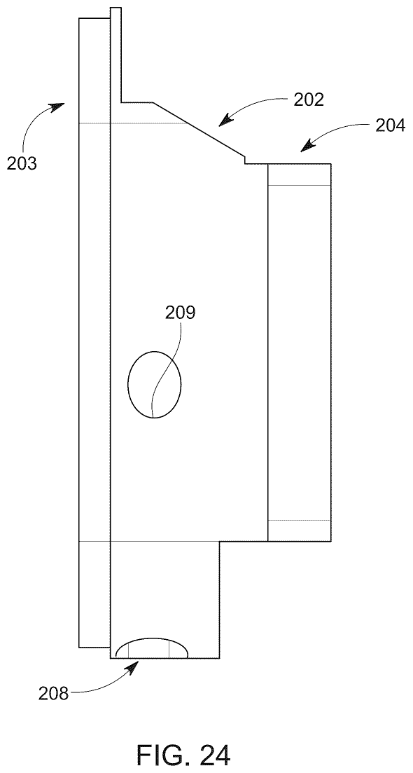

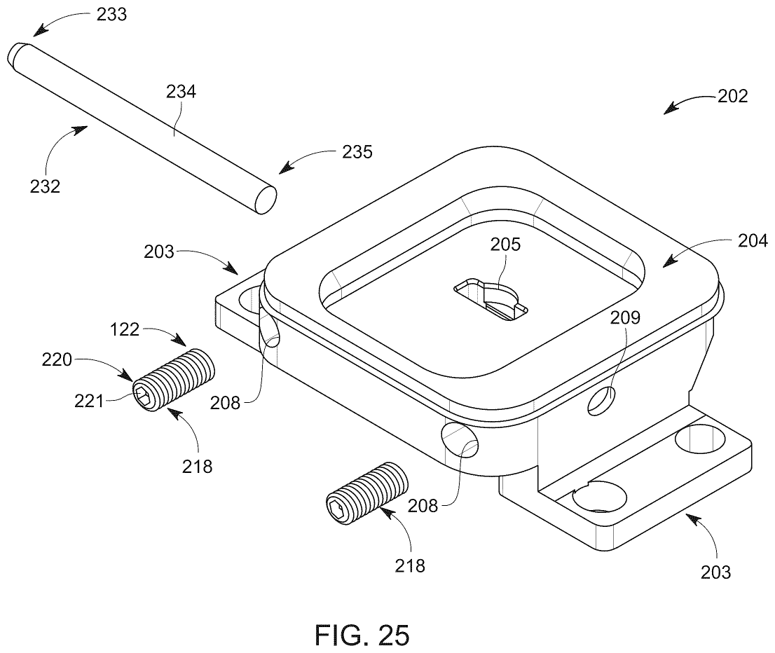

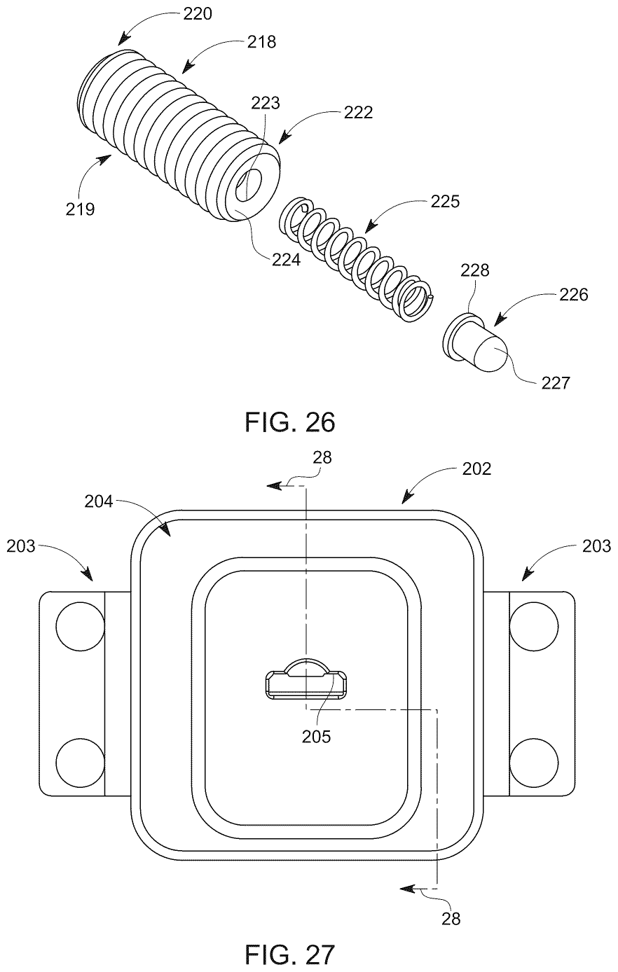

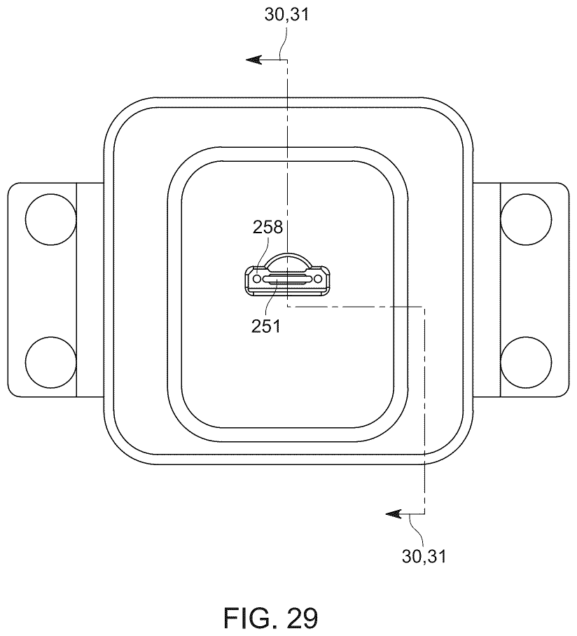

In one embodiment, illustrated in FIGS. 21-25 and 27-31, a fiber optic ferrule assembly adapter 202 can be used with a suitable optical fiber laser cleaving device, such as device 200 illustrated in FIG. 17, for connecting the fiber optic TMT ferrule assembly 250 thereto. In this example, the adapter 202 includes a mounting portion 203, configured and arranged to mount onto the device 200, and a frame portion 204, configured and arranged to receive the ferrule assembly 250. The frame portion 204 includes an aperture 205 with an opening 205a formed by opposing first and second sides 206a and 206b and opposing third and fourth sides 206c and 206d configured and arranged to receive the connector portion 254 of the ferrule assembly. The frame portion 204 also includes lateral bores 208 that intersect with and are in communication with a longitudinal bore 209. The lateral bores 208 are preferably positioned on opposing sides of the aperture 205, parallel to the third and fourth sides 206c and 206d, and a portion of the longitudinal bore 209 intersects the first side 206a, parallel to the first side 206a.

The lateral bores 208 are configured and arranged to receive biasing members 218, which in this example are spring plungers. Preferably, the lateral bores are formed by at least partially threaded walls 216 that are configured and arranged to mate with threaded exteriors 219 of the biasing members 218. This assists in keeping the biasing members 218 in desired positions relative to the frame portion 204. The biasing members 218 include generally cylindrical housings each having a first end 220, which forms a hex nut 221, and a second end 222 which forms a stop 224 narrowing an opening into a bore 223. A spring 225 is positioned in the bore 223 proximate the first end 220 with a ball portion 226 proximate the second end 222 so that the spring 225 biases the ball portion 226 to partially extend through the opening into the bore 223 formed by the stop 224. The ball portion 226 includes a flange 228 and a ball end 227. The spring 225 exerts force on the flange 228, and the flange 228 selectively contacts the stop 224 to prevent the ball portion 226 from coming out of the bore 223. The ball end 227 protrudes from the opening formed by the stop 224.

An engaging member 232, which is preferably a rod, extends through the longitudinal bore 209, which is preferably an oval shaped bore to allow the engaging member 232 to slide or translate between receiving/releasing and retaining positions relative to the aperture 205. The engaging member 232 is biased by the biasing members 218 into the retaining position, but as the connector portion 254 is inserted into and removed from the aperture 205, the engaging member 232 presses against the ball portions 226, thereby moving the ball portions 226 inward and compressing the springs 225, toward the receiving/releasing position. In this example, the engaging member 232 is a cylindrical rod having a first end 233, an intermediate portion 234, and a second end 235. A portion of the intermediate portion 234 is configured and arranged to contact the connector portion 254 within the aperture 205 and bias the connector portion 254 toward the opposing side, the second side 206b. The engaging member 232 contacts the connector portion 254 to more securely retain the connector portion within the aperture 205.

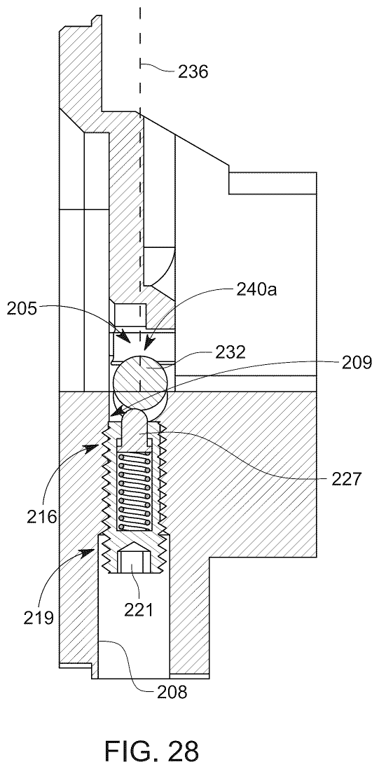

Preferably, to also more securely retain the connector portion 254 within the aperture 205, the diameter of the cylindrical rod is a center line 236, illustrated in FIGS. 28, 30, and 31, and the ball portion 226 engages the engaging member 232 off center relative to the center line 236, preferably off center proximate the opening 205a to the aperture 205.

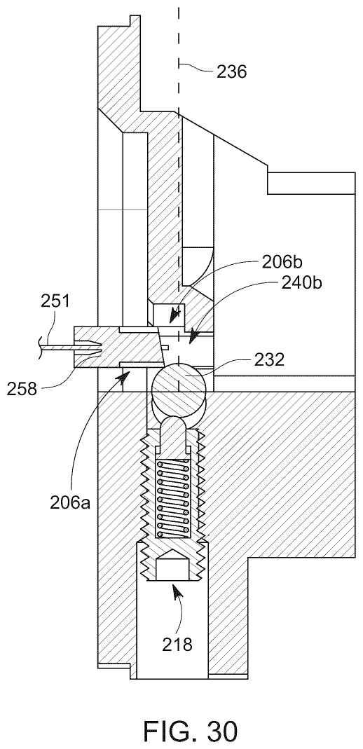

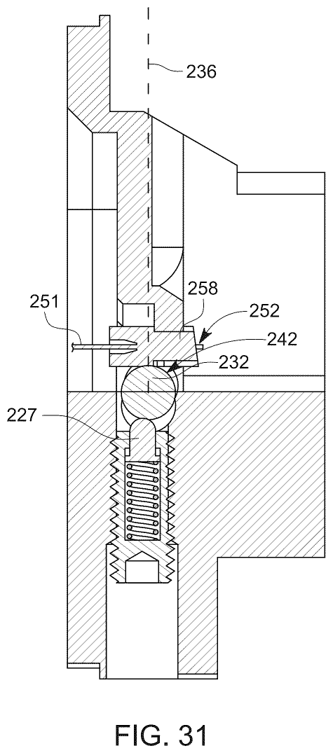

In operation, as illustrated in FIGS. 28, 30, and 31, as the connector portion 254 is inserted into the aperture 205, it contacts the engaging member 232, which rotates and slides or translates inward toward the biasing members 218, moving the ball portions 226 and compressing the springs 225. The receiving/releasing position includes a variety of positions from when the engaging member 232 is not contacted by the connector portion 254 to when it is partially contacted or engaged by the connector portion 254, for example the receiving/releasing positions 240a and 240b illustrated in FIGS. 28 and 30. When the connector portion 254 is positioned within the aperture 205, the engaging member 232 is biased by the biasing members 218 thereby biasing the connector portion 254 toward the second side 206b. The retaining position 242 is illustrated in FIG. 31. As the connector portion 254 is removed from the aperture 205, the engaging member 232 rotates and slides or translates inward toward the biasing members 218, moving the ball portions 226 and compressing the springs 225. In addition, preferably the engaging member 232 is configured and arranged to rotate as the connector portion 254 is inserted into and removed from the aperture 205 to assist in reducing wear on the engaging member 232 and preventing marring or drag marks on the connector portion 254.

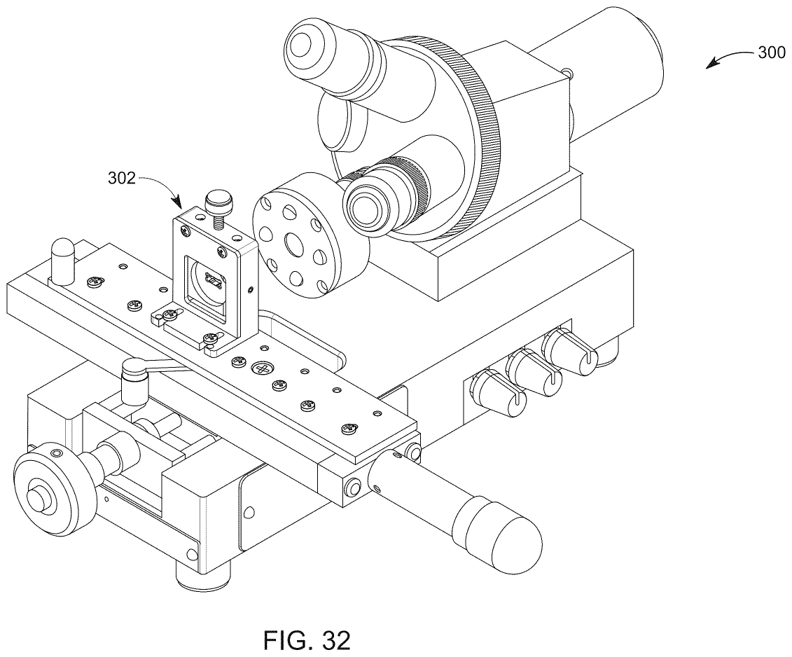

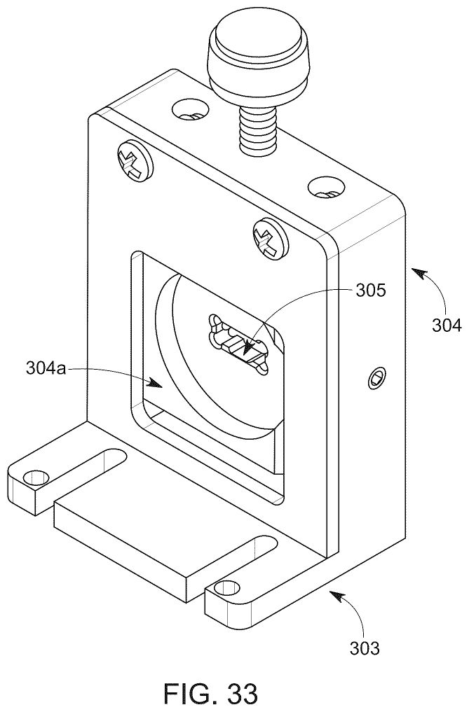

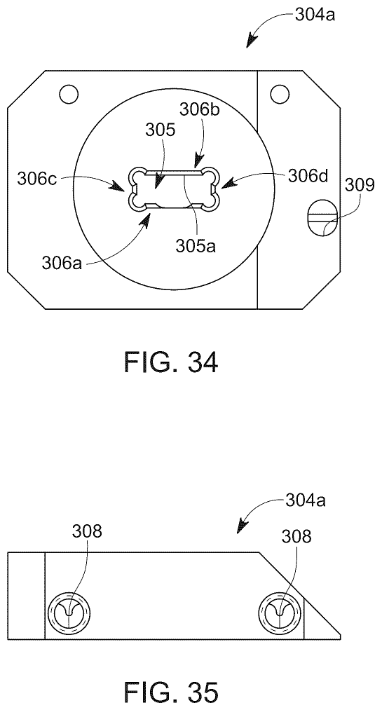

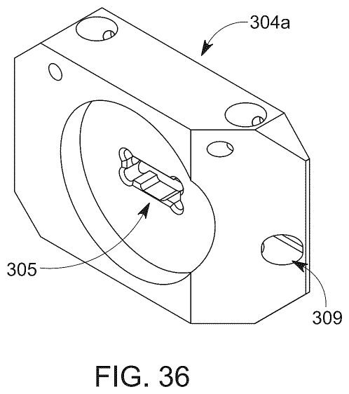

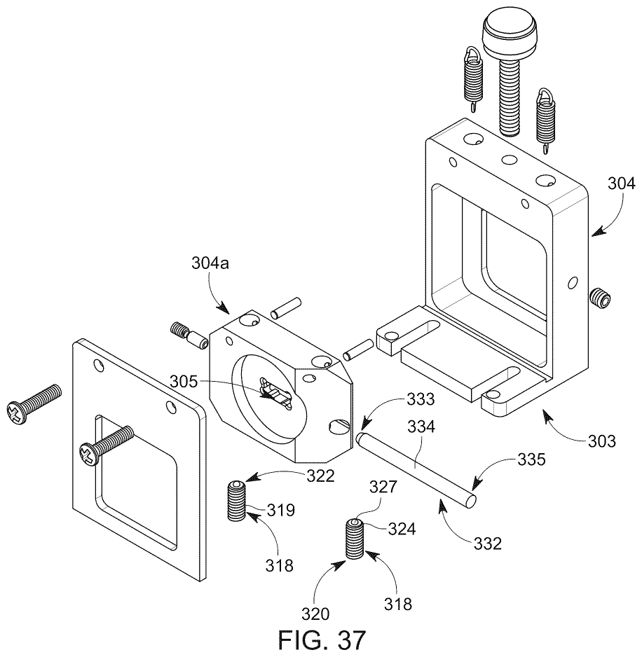

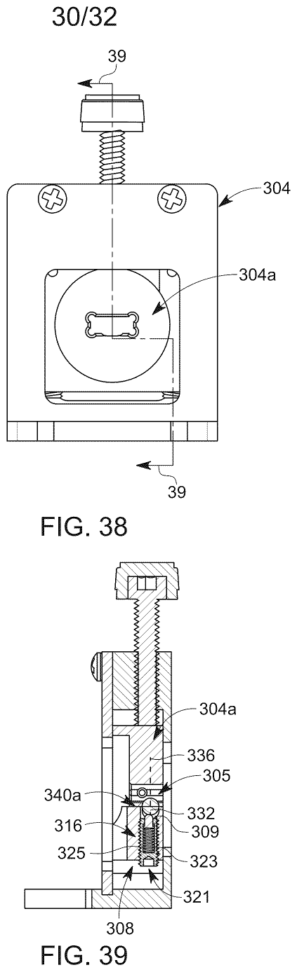

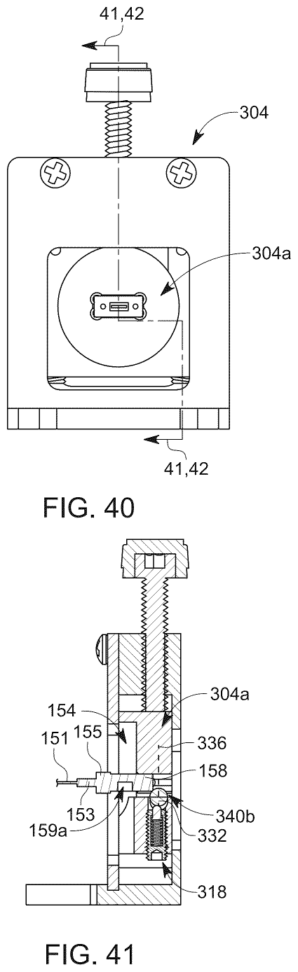

In one embodiment, illustrated in FIGS. 33 and 37-42, a fiber optic ferrule assembly adapter 302 can be used with a suitable device, such as microscope 300 illustrated in FIG. 32, for connecting the fiber optic MT ferrule assembly 150 thereto. In this example, the adapter 302 includes a mounting portion 303, configured and arranged to mount onto the device 300, and a frame portion 304 including an insert 304a, configured and arranged to receive the ferrule assembly 150. In this example, although the insert 304a is an individual, interchangeable component received by the frame portion 304, the insert 304a is considered part of the frame portion 304. Although shown for use with an MT ferrule assembly, the insert 304a could be configured and arranged to receive any one of a variety of ferrule assemblies. The insert 304a includes an aperture 305 with an opening 305a formed by opposing first and second sides 306a and 306b and opposing third and fourth sides 306c and 306d configured and arranged to receive the connector portion 354 of the ferrule assembly. The insert 304a also includes lateral bores 308 that intersect with and are in communication with a longitudinal bore 309. The lateral bores 308 are preferably positioned on opposing sides of the aperture 305, generally parallel to the third and fourth sides 306c and 306d, and a portion of the longitudinal bore 309 intersects the first side 306a, generally parallel to the first side 306a.

The lateral bores 308 are configured and arranged to receive biasing members 318, which in this example are spring plungers. Preferably, the lateral bores are formed by at least partially threaded walls 316 that are configured and arranged to mate with threaded exteriors 319 of the biasing members 318. This assists in keeping the biasing members 318 in desired positions relative to the frame portion 304. The biasing members 318 include generally cylindrical housings each having a first end 320, which forms a hex nut 321, and a second end 322 which forms a stop 324 narrowing an opening into a bore 323. A spring 325 is positioned in the bore 323 proximate the first end 320 with a ball portion 326 proximate the second end 322 so that the spring 325 biases the ball portion 326 to partially extend through the opening into the bore 323 formed by the stop 324. The ball portion 326 includes a flange and a ball end 327. The spring 325 exerts force on the flange, and the flange selectively contacts the stop 324 to prevent the ball portion 326 from coming out of the bore 323. The ball end 327 protrudes from the opening formed by the stop 324.

An engaging member 332, which is preferably a rod, extends through the longitudinal bore 309, which is preferably an oval shaped bore to allow the engaging member 332 to slide or translate between receiving/releasing and retaining positions relative to the aperture 305. The engaging member 332 is biased by the biasing members 318 into the retaining position, but as the connector portion 154 is inserted into and removed from the aperture 305, the engaging member 332 presses against the ball portions 326, thereby moving the ball portions 326 inward and compressing the springs 325, toward the receiving/releasing position. In this example, the engaging member 332 is a cylindrical rod having a first end 333, an intermediate portion 334, and a second end 335. A portion of the intermediate portion 334 is configured and arranged to contact the connector portion 154 within the aperture 305 and bias the connector portion 154 toward the opposing side, the second side 306b. The engaging member 332 contacts the connector portion 154 to more securely retain the connector portion within the aperture 305.

Preferably, to also more securely retain the connector portion 154 within the aperture 305, the diameter of the cylindrical rod is a center line 336, illustrated in FIGS. 39, 41, and 42, and the ball portion 326 engages the engaging member 332 off center relative to the center line 336, preferably off center proximate the opening 305a to the aperture 305.

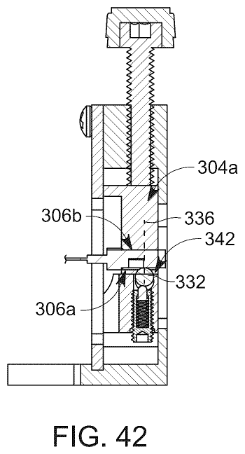

In operation, as illustrated in FIGS. 39, 41, and 42, as the connector portion 154 is inserted into the aperture 305, it contacts the engaging member 332, which rotates and slides or translates inward toward the biasing members 318, moving the ball portions 326 and compressing the springs 325. The receiving/releasing position includes a variety of positions from when the engaging member 332 is not contacted by the connector portion 154 to when it is partially contacted or engaged by the connector portion 154, for example the receiving/releasing positions 340a and 340b illustrated in FIGS. 39 and 41. When the connector portion 154 is positioned within the aperture 305, the engaging member 332 is biased by the biasing members 318 thereby biasing the connector portion 154 toward the second side 306b. The retaining position 342 is illustrated in FIG. 42. As the connector portion 154 is removed from the aperture 305, the engaging member 332 rotates and slides or translates inward toward the biasing members 318, moving the ball portions 326 and compressing the springs 325. In addition, preferably the engaging member 332 is configured and arranged to rotate as the connector portion 154 is inserted into and removed from the aperture 305 to assist in reducing wear on the engaging member 332 and preventing marring or drag marks on the connector portion 154.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A fiber optic ferrule assembly adapter for use with a fiber optic ferrule assembly including at least one optical fiber routed through a connector portion, comprising:
a frame portion including an aperture configured and arranged to receive the connector portion of the fiber optic ferrule assembly; and
an engaging member operatively connected to the frame portion and positioned proximate a first side of the aperture configured and arranged to bias the connector portion toward an opposing second side of the aperture and selectively retain the connector portion within the aperture when the fiber optic ferrule assembly is positioned within the aperture.

2. The fiber optic ferrule assembly adapter of claim 1, further comprising a biasing member positioned between the frame portion and the engaging member, the biasing member selectively moving the engaging member relative to the frame portion.

3. The fiber optic ferrule assembly adapter of claim 2, wherein the biasing member is a spring plunger operatively connected to the frame portion.

4. The fiber optic ferrule assembly adapter of claim 1, wherein the engaging member is a cylindrical rod extending parallel to the first side of the aperture.

5. The fiber optic ferrule assembly adapter of claim 4, wherein the cylindrical rod is configured and arranged to rotate as the fiber optic ferrule assembly is inserted and removed from within the aperture.

6. The fiber optic ferrule assembly adapter of claim 4, further comprising a biasing member interconnecting the frame portion and the rod, the biasing member including a first spring plunger positioned proximate the first side and a third side of the aperture and a second spring plunger positioned proximate the first side and a fourth side of the aperture.

7. The fiber optic ferrule assembly adapter of claim 4, further comprising a biasing member interconnecting the frame portion and the rod, wherein the rod has a center line and the biasing member engages the rod off center relative to the center line.

8. The fiber optic ferrule assembly adapter of claim 7, wherein the biasing member engages the rod off center proximate an opening to the aperture.

9. The fiber optic ferrule assembly adapter of claim 1, wherein the adapter is configured and arranged to be operatively connected to a device selected from the group consisting of a laser cleaving device and a microscope.

10. The fiber optic ferrule assembly adapter of claim 1, wherein an insert received by the frame portion includes the aperture and is operatively connected to the engaging member.

11. A fiber optic ferrule assembly adapter for use with a fiber optic ferrule assembly including at least one optical fiber routed through a connector portion, comprising:
a frame portion including an aperture configured and arranged to receive the connector portion of the fiber optic ferrule assembly;
a biasing member operatively connected to the frame portion; and
an engaging member positioned proximate a first side of the aperture, the biasing member positioned between the frame portion and the engaging member and placing a biasing force on the engaging member away from the frame portion to bias the connector portion toward an opposing second side of the aperture and selectively retain the connector portion within the aperture when the fiber optic ferrule assembly is positioned within the aperture.

12. The fiber optic ferrule assembly adapter of claim 11, wherein the biasing member is a spring plunger operatively connected to the frame portion.

13. The fiber optic ferrule assembly adapter of claim 11, wherein the engaging member is a cylindrical rod extending parallel to the first side of the aperture.

14. The fiber optic ferrule assembly adapter of claim 13, wherein the cylindrical rod is configured and arranged to rotate as the fiber optic ferrule assembly is inserted and removed from within the aperture.

15. The fiber optic ferrule assembly adapter of claim 13, wherein the biasing member includes a first spring plunger positioned proximate the first side and a third side of the aperture and a second spring plunger positioned proximate the first side and a fourth side of the aperture.

16. The fiber optic ferrule assembly adapter of claim 13, wherein the rod has a center line and the biasing member engages the rod off center relative to the center line.

17. The fiber optic ferrule assembly adapter of claim 16, wherein the biasing member engages the rod off center toward an opening to the aperture.

18. The fiber optic ferrule assembly adapter of claim 11, wherein the adapter is configured and arranged to be operatively connected to a device selected from the group consisting of a laser cleaving device and a microscope.

19. The fiber optic ferrule assembly adapter of claim 11, wherein an insert received by the frame portion includes the aperture and is operatively connected to the biasing member and the engaging member.
